(19) United States
(12) Patent Application Publication
(10) Pub. No.: US 2015/0178827 A1
(43) Pub. Date: Jun. 25, 2015

(54) COMPUTER MODELING OF PROPERY TAX DELINQUENCY RISK

(71) Applicant: CoreLogic Solutions, LLC, Irvine, CA (US)

(72) Inventors: Dingxi Qiu, Glenn Allen, VA (US); Wei Liu, Southlake, TX (US)

(73) Assignee: CoreLogic Solutions, LLC, Irvine, CA (US)

(21) Appl. No.: 14/292,539

(22) Filed: May 30, 2014

Related U.S. Application Data
(60) Provisional application No. 61/918,413, filed on Dec. 19, 2013.

(51) Int. Cl. G06Q 40/02; G06F 17/30

(52) U.S. Cl. CPC G06Q 40/02; G06F 17/30241

(57) ABSTRACT

A computer model of tax delinquency risk is generated by analyzing historical data, including mortgage loan data, associated with real estate properties that have become property tax delinquent. The model is used to generate property-specific scores representing the likelihood that the corresponding properties will become tax delinquent (absent lender or servicer intervention) within a selected time period, such as six months. The scores may, for example, be used by a mortgage lender or servicer to identify loans/properties for which to take preemptive action to avoid tax delinquency.

### PRIORITY CLAIM

The present disclosure claims the benefit of U.S. Provisional Appl. No. 61/918,413, filed Dec. 19, 2013, the disclosure of which is hereby incorporated by reference.

### TECHNICAL FIELD

The present disclosure relates to data processing methods for generating and applying computer models for estimating the risk that a certain type of event will occur.

### BACKGROUND

In the United States, real estate taxes are assessed by various taxing authorities. The taxes are generally based on the values of properties, including land. The taxing jurisdictions include counties, cities, towns, boroughs, and schools. Different locations have different types of property taxes. For example, a property in Illinois may only have county taxes assessed, but a property in Texas could have county, city and school taxes assessed.

Mortgage lenders and servicers need to track and pay taxes on escrowed and non-escrowed loans. Servicers disburse taxes to the taxing authorities on escrowed loans from borrowers' escrow accounts. For non-escrowed loans, servicers monitor delinquent taxes and request proof of payment from the borrowers. If a response is not received, servicers commonly advance funds to make the payment. This protects the lender's interest in the property and avoids a tax lien being placed on the property. When a tax lien is placed on a property it often extinguishes the mortgage lien. When incorrect or late tax payments are made by servicers, it incurs penalty and late fees that are not reimbursed by the lenders.

No more than about 2-3% of the properties in a mortgage portfolio are typically tax delinquent at a time. The task of identifying which of the many thousands of properties in a mortgage portfolio are tax delinquent, or at risk of soon becoming tax delinquent, is very labor intensive and time consuming. The failure to promptly identify such properties can be very costly to lenders and services.

### SUMMARY

A computer model of tax delinquency risk is generated by analyzing historical data, including mortgage loan data, associated with real estate properties that have become property tax delinquent. The model is used to generate property-specific scores representing the likelihood that the corresponding properties will become tax delinquent (absent lender or servicer intervention) within a selected time period, such as six months. The scores may, for example, be used by a mortgage lender or servicer to identify loans/properties for which to take preemptive action to avoid tax delinquency.

Neither this summary nor the following detailed description purports to define the invention. The invention is defined by the claims.

### BRIEF DESCRIPTION OF THE DRAWINGS

FIG. 1 illustrates components of a computer-based system that generates property-specific scores representing the likelihood of entry into a tax delinquency within a defined period of time.

FIG. 2 illustrates a process that may be used by the system of FIG. 1 to generate a tax delinquency scoring model based on historical data.

FIG. 3 illustrates an automated process that may be implemented by the system of FIG. 1 to generate tax delinquency risk scores for specific properties.

FIG. 4 illustrates how the tax delinquency risk scores of multiple properties can be used in combination to generate monetary shortfall estimates.

### DETAILED DESCRIPTION OF SPECIFIC EMBODIMENTS

Specific, non-limiting embodiments will now be described with reference to the drawings. Nothing in this description is intended to imply that any particular feature, component or step is essential. The inventive subject matter is defined by the claims.

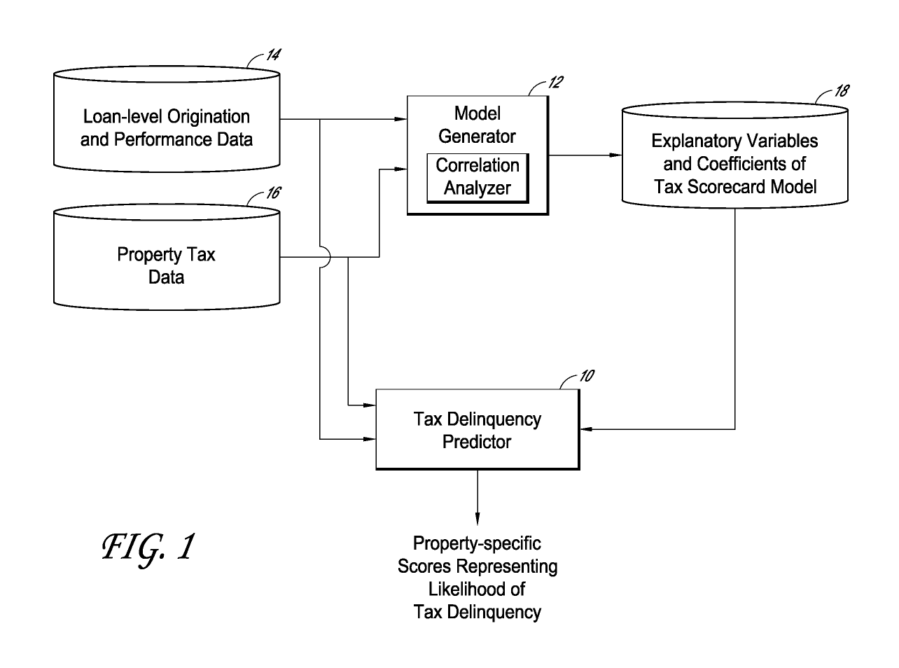

FIG. 1 illustrates the functional components of a computer-based system for assessing property-specific tax delinquency risk according to one embodiment. The system includes a tax delinquency predictor component 10 that generates property-specific tax delinquency risk scores. Each such score represents, or is positively correlated with, a predicted likelihood that a corresponding residential real estate property will, within a defined time period, become tax delinquent if no preemptive action is performed. The scores thus represent the likelihoods that the corresponding property owners will fail to pay the property taxes when they become due. In one embodiment, the scores are generated according to a process in which (1) each score represents a likelihood of the corresponding property becoming tax-delinquent within six months, and (2) each 50-point increase in the score represents a doubling of the odds of tax delinquency events. Other scoring methods, scoring scales, and delinquency timeframes may alternatively be used; for example, the scores could be generated as probability values on a scale of 0 to 100.

As discussed below, the tax delinquency predictor 10 generates the scores using data regarding corresponding mortgage loans, such as mortgage payment history data. Mortgage payment history tends to be very useful for predicting future property tax delinquency because mortgage payments are ordinarily due more frequently than property tax payments. (Typically, mortgage payments are due monthly, while property taxes are due quarterly, bi-annually or annually.) Because of this difference in payment frequency, borrowers usually become delinquent on their mortgage payments before becoming delinquent on property tax payments. The tax delinquency predictor 10 preferably takes advantage of this characteristic by relying relatively heavily on the borrower's recent mortgage payment history.

The scores generated by the tax delinquency predictor for a given borrower may also take into account such factors as (1) the amount of time until the borrower's next property tax payment is due, (2) the amount of this payment, (3) the amount or percentage of change between this payment and the preceding property tax payment, and (4) whether this borrower has previously been property-tax-delinquent on the subject property or another property. Where property tax amounts are considered, these amounts may be looked up from property tax records, or may be estimated based on an AVM-based or HPI (Housing Price Index) based valuations and associated tax rates and rules of the relevant jurisdictions.

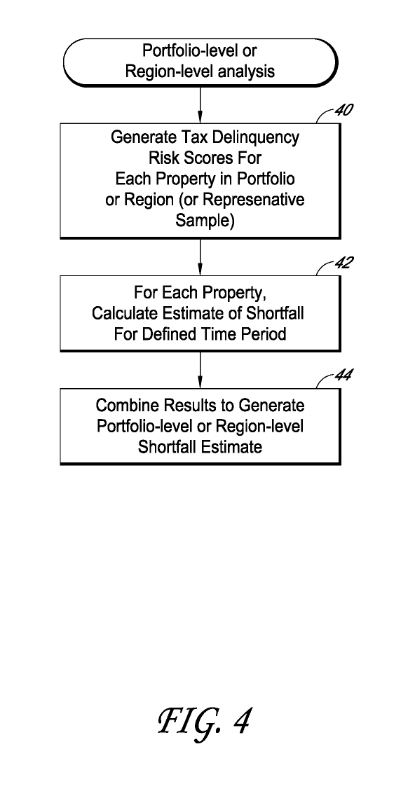

The scores generated by the system can be used in various ways. For example, a lender or mortgage servicer can use the scores to identify high-risk borrowers and properties for which to take preemptive actions. Such preemptive actions may include, for example, contacting the borrower to negotiate payment, or making a property tax payment on behalf of the borrower to prevent the property from becoming delinquent. For instance, a lender may obtain tax delinquency risk scores for all properties/mortgages in its portfolio, and may use these scores to rank the mortgages in terms of tax delinquency risk. The lender may then use the list to select properties/borrowers for which to take preemptive action. The system is particularly useful for non-escrowed mortgages, as lenders ordinarily have little or no advance warning of imminent tax delinquency for such accounts. As discussed below with reference to FIG. 4, the scores can also be used on an aggregated basis to predict, for example, (1) how much a lender will have to pay out in a defined time period to protect a portfolio of mortgages from tax delinquency, or (2) an amount of a tax revenue shortfall for a specific jurisdiction or region.

As shown in FIG. 1, the system preferably uses two primary sources of data to generate the scores, and to generate the model on which the scores are based. The first is a data repository 14 of loan-level origination and performance data. This data repository 14 contains information regarding specific mortgage loans; this information may include, for example, property address, parcel number, mortgage payment/delinquency history, loan age, borrower FICO score at origination, interest rate at origination, loan term, origination load-to-value ratio, and various other loan attributes. One example of such a data repository is the Loan-Level Market Analytics database maintained by CoreLogic, Inc. based on loan-specific data contributed by various lenders and servicers.

The second data repository 16 contains property tax data for specific real estate properties, which may be identified by parcel number and/or property address. The tax data stored for a given property may include, for example, tax amounts due, associated due dates, payment/delinquency history, and current delinquency status. In one embodiment, this data repository 16 is generated based on tax data collected from the public assessor offices in various jurisdictions throughout the United States.

As shown in FIG. 1, a model generator 12 uses historical data stored in these two data repositories 14, 16 to generate a computer model (also referred to as a tax scorecard model) for generating the delinquency risk scores. More specifically, the model generator 12 uses the repository of property tax data 16 to identify properties that have become tax delinquent, and uses the loan-level data repository 16 to look up corresponding information associated with the mortgage loans that were in place at the time. A correlation analyzer 12A uses this information, as aggregated over many properties (typically thousands) that have become tax-delinquent, to identify and quantify correlations between (1) loan characteristics and performance events, and (2) property tax delinquency events. (Loan attributes of properties that have not become tax delinquent may also be considered during this process.) For example, such an evaluation has shown that mortgage payment delinquency is a strong driver or predictor of near-term property tax delinquency. In one embodiment, the model generator 12 uses logistic regression to generate the model. Logistic regression is well known in the art. In other embodiments, the model generator 12 additionally or alternatively uses linear regression, decision trees, a classification and regression tree (CART) model, a fuzzy logic technique, a support vector machine (SVM) of one or more classes, a Naïve Bayes technique, a boosting tree, a scorecard, and/or an expert system to generate the model. The model may be generated based solely on data collected in connection with non-escrowed mortgage accounts.

As shown by the data repository 18 in FIG. 1, the output of the model generator 12 includes (1) a set of explanatory variables representing specific property-related (and typically loan-related) attributes that have correlations with tax delinquency risk, and (2) a corresponding set of coefficients representing the strength and type (positive or negative) of the correlation. An example of an explanatory variable is “number of missing mortgage payments over last 3 months.” The coefficient for this variable may, for example, be 0.3, indicating a strong, positive correlation between this loan attribute and tax delinquency occurrences. Explanatory variables may also be used for such loan-related attributes as borrower FICO score at loan origination, current FICO score of borrower, mortgage interest rate, mortgage type, mortgage age, and whether the property has dropped in value from loan origination by more than a threshold percentage.

Other types of property-related attributes may also be considered, including attributes that are not tied to a particular mortgage. Examples include multiple-property ownership by the borrower, non-occupancy of the property by the borrower, whether a construction permit or construction loan was recently issued for the property, and whether average housing prices have recently dropped in the neighborhood or region of the property, and whether the borrower/owner has previously failed to make a property tax payment on this or another property. Thus, the system may use data sources other than those shown in FIG. 1 to generate the model and the tax delinquency risk scores.

As shown in FIG. 1, the tax delinquency predictor 10 uses the model coefficients, in combination with tax data and loan-level data (and/or other property-related data) for specific properties, to generate the tax delinquency risk scores for specific properties. In one embodiment, the tax delinquency predictor 10 calculates the likelihood of tax delinquency according to the following equation:

$$Pr ( Y = 1 ) = \frac{1}{1 + exp ( - X β )}$$

where (1) Y=1 represents the tax delinquency case within 6 months, (2) X represents the property-related attributes such as mortgage delinquency, FICO score at loan origination, loan-to-value ratio at origination, etc., and (3) the βs are the coefficients or weights applied to specific property-related attributes. In one embodiment, the final tax delinquency risk score is constructed as:

Score=f(Xβ),

where f(•) is a function to scale the score so that every 50 points doubles the odds that a property will be tax delinquent within 6 months of the current date. Typical scores fall in the range of 400 to 800. The time period of six months allows lenders or services sufficient time to take preemptive actions. Other time periods can alternatively be used, such as time periods falling in the range of 4 to 8 months, 3 to 9 months or 1 to 12 months.

The system shown in FIG. 1 may be implemented by a computer system that comprises one or more physical computers or computing devices, which may but need not be co-located. The computer system may be programmed with program code modules that are stored on one or more non-transitory computer storage devices (hard disk drives, solid state memory devices, etc.) for performing the functions described above and in further detail below. Some or all of the functions may alternatively be implemented in application-specific circuitry (ASICs, FPGAs, etc.) of the computer system. The illustrated data repositories 14, 16, 18 may be implemented as one or more databases, flat file systems, or other types of data storage systems that use non-transitory computer storage devices to persistently store data.

Although not shown in FIG. 1, the system may include a user interface component that enables lenders, mortgage servers, and/or other classes of users to request and obtain tax delinquency risk scores (or reports based on such scores) for specific properties. For example, the system may host a web-based or other interactive user interface and service than enables a user to specify a particular property (e.g., by property address, parcel number, mortgage loan number or other identifier) or to upload a list of properties. The system may then generate and return a web page, spreadsheet, or other document containing the corresponding score or scores. Where multiple properties are specified, the system may also rank the properties based on the scores. As explained below, the system may also enable the user to perform a higher level analysis on a group of properties or mortgages.

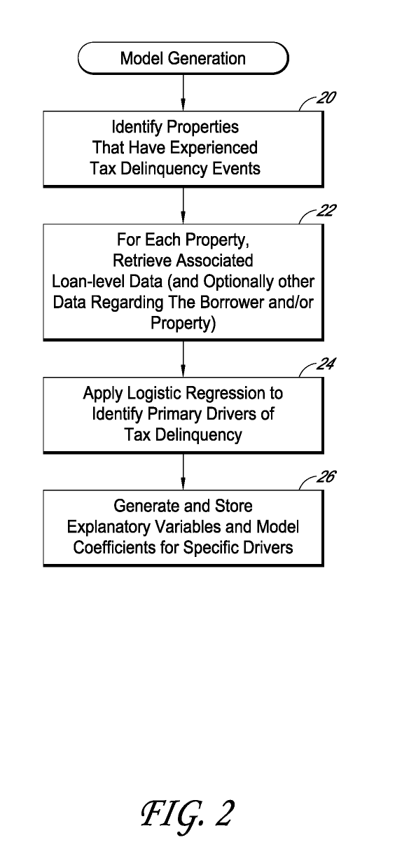

FIG. 2 illustrates the process that may be implemented by the model generator 10 of FIG. 1 to generate a model based on historical data. This process may be re-executed periodically (e.g., weekly, monthly or yearly) to incorporate new data. The process may use a defined look-back horizon (e.g., 5 years, 10 years, etc.), and/or may give more weight to recent historical data than to older historical data.

In block 20, the process identifies real estate properties that have experienced tax delinquency events using data retrieved from the property tax data repository 16. In some embodiments, properties that were the subject of an escrowed mortgage loan (as may be determined from the associated loan-level data) may be excluded or filtered from this list. In some embodiments, the process may also identify properties that have not entered into tax delinquency; consideration of such properties is useful for, e.g., identifying loan attributes or other property-related attributes that are negatively correlated with tax delinquency risk.

In block 22, the process retrieves property-related attributes for the properties identified in block 20. In some embodiments, the property-related attributes for properties that became tax delinquent consist of attributes of the mortgages that were in place on the properties at the time of, or shortly before, the associated tax delinquency events. In other embodiments, the process may also retrieve and use other types of property-related attributes, as described above.

In block 24, the process applies logistic regression to identify the attributes that represent the primary drivers of tax delinquency. In some embodiments, this may involve searching for attribute combinations that are correlated with tax delinquency. For example, the process may determine that the combination of (1) a loan-to-value ratio above a certain threshold, and (2) non-occupancy by the owner/borrower, has a strong correlation with tax delinquency. Preferably, the property-related attributes of both tax delinquent and non-tax delinquent properties are analyzed in block 24.

In block 26, the process generates and stores the explanatory variable definitions and associated coefficients for the identified drivers. One example of a set of explanatory variables and associated coefficients is shown in Table 1 below. A numerical example that uses these variables and coefficients is provided below. Negative coefficients in this example represent negative correlations between the associated attribute and tax delinquency risk.

TABLE 1

| Variable | Definition | Coefficient (f3) |
|---|---|---|
| x_last3mo | Number of missing mortgage payments | 0.35 |
| | over the last 3 months | |
| origination_fico_ | FICO Score at Origination | −.01 |
| score | | |
| initial_rate | Mortgage rate at origination (%) | 0.25 |
| age | Mortgage loan age | −0.01 |
| x_LE36GT360 | Mortgages with extreme loan terms | 0.20 |
| | (>30 years or <3years) | |
| origination_ltv | Loan to value at origination (percentage) | 0.01 |
| flag_missLTV | Dummy for missing LTV at origination | −0.22 |
| flag_missFICO | Dummy for missing FICO score | 0.35 |
| | at origination | |

Although the property-related attributes in this example consist of loan-related attributes, non-loan-related attributes may also be considered, as explained above. The following are examples of other (non-loan-level) explanatory variables that may be used: (1) number of months until next property tax payment is due, (2) percentage increase in next property tax payment amount relative to last property tax payment amount, (3) percentage increase in value of property over last year, (4) whether the borrower has previously been tax delinquent on this property, (5) whether the borrower has previously been tax delinquent on other properties.

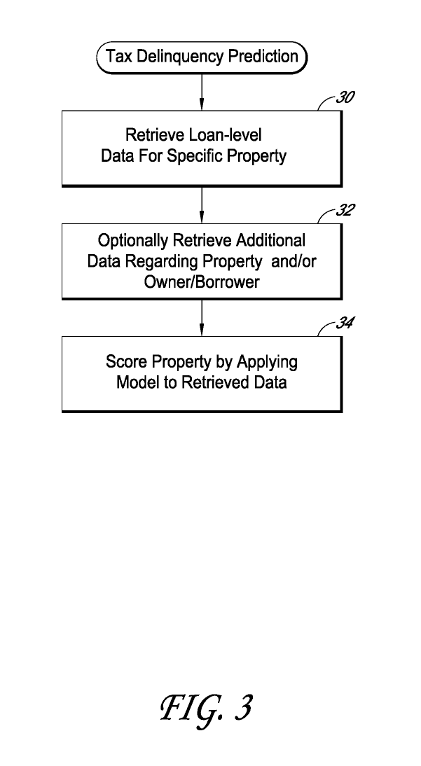

FIG. 3 illustrates the process implemented by the tax delinquency predictor 10 to generate the tax delinquency risk score for a particular property. This process may be performed periodically to incorporate new data associated with the borrower and/or property; for example, it may be performed monthly (or more frequently than monthly) so that missed or late mortgage payments by the borrower are promptly taken into consideration. In block 30, the process retrieves the loan-level attribute data for the property. Ideally this data includes recent mortgage payment history data, since mortgage delinquency is a strong driver of tax delinquency. In block 32, the process may also retrieve other (non-mortgage) types property-related attribute data, examples of which are provided above. In block 34, the process generates the tax delinquency risk score by applying the tax scorecard model to the retrieved attribute data.

For example, suppose the explanatory variables for a particular property are as shown in Table 2.

TABLE 2

| Variable | Definition | Measurement |
|---|---|---|
| x_last3mo | Number of missing mortgage payments | 1 |
| | over the last 3 months | |
| origination_fico_ | FICO Score at Origination | 730 |
| score | | |
| initial_rate | Mortgage rate at origination (%) | 5.6 |
| age | Mortgage loan age (months) | 75 |
| x_LE36GT360 | Mortgages with extreme loan terms | 0 |
| | (>30 years or <3 years) | |
| origination_ltv | Loan to value at origination | 65 |
| flag_missLTV | Dummy for missing LTV at origination | 0 |
| flag_missFICO | Dummy for missing FICO score | 0 |
| | at origination | |

Using the model coefficients of Table 1, the property's tax delinquency risk score may be generated as follows:

$$\begin{matrix}ln ( odds ) = ln [ \frac{Pr ( Y = 1 )}{1 - Pr ( Y = 1 )} ] = X β \\ = 2.43 + 0.35 * x\_last3mo - 0.01 * origination\_fico \_score + \\ 0.25 * initial\_rate - 0.01 * age + 0.20 * x\_LE36GT360 + 0.01 * \\ origination\_ltv - 0.22 * flag\_missLTV + 0.35 * flag\_missFICO ;\end{matrix}$$

A one-to-one functional relationship exists between log odds and the probability of tax delinquency. In this particular example,

$$ln ( odds ) = X β = - 3.22 ; and$$

$$Pr ( Y = 1 ) = \frac{1}{1 + exp ( - X β )} = 0.0384$$

Finally the tax scorecard model will output a tax delinquency score based on the log odds or the tax delinquency risk:

Score=732.19281+72.13475*Xβ=500

A score of 400 corresponds to an odds of 1:100. Scores are scaled in this example such that the odds of tax delinquency double for every 50 point increment in the score. Therefore, the odds (i.e., Pr(Y=1)/Pr(Y=0)) for this sample property to be tax delinquent in the next payment is about 1:25.

In some embodiments, the scores may be generated or adjusted to reflect the different tax delinquency rules of different states or jurisdictions. For example, some states have different rules governing (1) whether a property tax lien trumps a mortgage lien, (2) when foreclosure proceedings can be initiated, and (3) what penalties are assessed for tax delinquency. These rules may impact both the likelihood of tax delinquency and the borrower's consequences for tax delinquency, and may therefore be considered in some embodiments.

FIG. 4 illustrates a process that may be used to perform a portfolio-level or region-level analysis, particularly to estimate a monetary shortfall amount. This process may, for example, be used by a lender to estimate the amount it will have to pay out in tax payments over a selected time period to prevent the properties associated with a mortgage portfolio from becoming tax delinquent. As another example, the process may be used to estimate the amount of a tax revenue shortfall (or surplus) in a given region.

In block 40 of FIG. 4, the process generates tax delinquency risk scores for each, or a representative sample of, the properties in a mortgage portfolio or geographic region using the processes described above. In block 42, the process calculates the estimated tax shortfall amount for each property for a defined time period, such as the following six months. This amount may be calculated based on the property's tax delinquency risk score and the tax amount due within the relevant time period. For example, the probability of tax delinquency may be multiplied by the tax amount due within the relevant time period.

In block 44, the estimated shortfall amounts are summed or otherwise combined to generate the estimated shortfall amount for the entire portfolio or region.

All of the processes and process steps described above (including those of FIGS. 2-4) may be embodied in, and fully automated via, software code modules executed by one or more general purpose computers or computing devices. The code modules may be stored in any type of non-transitory computer-readable medium or other computer storage or storage device. As mentioned above, some or all of the methods or steps may alternatively be embodied in specialized computer hardware. The results of the disclosed methods and tasks may be persistently stored by transforming physical storage devices, such as solid state memory chips and/or magnetic disks, into a different state.

Thus, all of the methods and tasks described herein may be performed and fully automated by a programmed or specially configured computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other computer-readable storage medium.

The foregoing description is intended to illustrate, and not limit, the inventive subject matter. The scope of protection is defined by the claims. In the following claims, any reference characters are provided for convenience of description only, and not to imply that the associated steps must be performed in a particular order.

What is claimed is:

1. A system, comprising:
a data repository that stores loan-level data for each of a plurality of mortgage loans, said loan-level data including payment performance data and including identifiers of associated real estate properties; and
a computer system comprising one or more computing devices, the computer system programmed to generate, for specific real estate properties, respective tax delinquency risk scores using at least the loan-level data for the corresponding properties, each tax delinquency risk score representing a likelihood that a corresponding real estate property will become tax delinquent within a defined time period, and being based at least partly on a mortgage payment history of an associated borrower, said mortgage payment history corresponding to a mortgage payment schedule having a higher payment frequency than a property tax payment schedule for the corresponding real estate property;
wherein the computer system is programmed to generate the tax delinquency risk scores using a model that correlates specific loan-level attributes with tax delinquency risk based on historical loan-level data associated with real estate properties that have entered into tax delinquency.

2. The system of claim 1, wherein the risk scores are additionally based in part on associated amounts of time until a next property tax payment is due.

3. The system of claim 1, wherein the loan-level attributes include loan-to-value ratios associated with particular loans.

4. The system of claim 1, wherein the computer system generates the tax delinquency risk scores based additionally on non-loan-level data associated with particular real estate properties.

5. The system of claim 1, wherein the defined period of time falls within the range of one to twelve months.

6. The system of claim 1, wherein the model uses logistic regression to generate the tax delinquency risk scores.

7. The system of claim 1, further comprising a model generation component that generates the model at least partly by analyzing the loan-level data in conjunction with tax delinquency event data to identify correlations between loan attributes and tax delinquency.

8. The system of claim 1, further comprising a component that uses the tax delinquency risk scores associated with a group of properties to estimate a tax revenue shortfall for a jurisdiction.

9. The system of claim 1, further comprising a component that uses the tax delinquency risk scores associated with a portfolio of mortgages to estimate a total tax property amount that will need to be contributed to maintain the properties in the portfolio in a non-tax-delinquent state.

10. A computer implemented method, comprising:
retrieving attribute data associated with a real estate property, said attribute data including attributes of a mortgage loan associated with the property; and
generating a score that represents a likelihood that the property will become property tax delinquent within a selected period of time, wherein generating the score comprises applying a computer model to the attribute data associated with the real estate property, including the attributes of said loan, said model based on detected correlations between tax delinquency events and particular property-related attributes;
said method performed programmatically by a computer system that comprises one or more computing devices.

11. The method of claim 10, wherein applying the model comprises calculating a score component that is based a mortgage payment delinquency attribute associated with the property.

12. The method of claim 10, wherein the score is based in part on a mortgage rate associated with the mortgage loan.

13. The method of claim 10, wherein the score is based at least partly on one or more non-loan-related attributes associated with the property.

14. The method of claim 10, wherein the defined period of time falls within the range of three months to nine months

15. The method of claim 10, wherein the model is based on logistic regression.

16. The method of claim 10, further comprising using the score to determine whether to initiate a preemptive action that reduces the risk of entry of the property into tax delinquency.

17. A system, comprising:
a data repository that stores property-related attributes of each of a plurality of real estate properties, said property-related attributes including mortgage loan attributes;
a data repository that stores property tax data for said properties, including data regarding property tax delinquency events; and
a computer system comprising one or more computing devices, the computer system programmed to use the property-related attributes and the property tax data in combination to generate detect and quantify correlations between particular property-related attributes and property-tax delinquency risk.

18. The system of claim 17, wherein the computer system is programmed to use logistic regression to detect the correlations.

19. The system of claim 17, wherein the computer system is programmed to generate parameters of a model that calculates a probability that a property will become property-tax delinquent within a specified period of time.

20. The system of claim 19, further comprising a component that uses the model, in combination with property-related attributes of a property, to calculate a property-specific score representing a likelihood that the property will become property tax delinquent within a selected period of time.
